(19) United States
(12) Patent Application Publication
(10) Pub. No.: US 2025/0369498 A1
(43) Pub. Date: Dec. 4, 2025

(54) DAMPING FORCE VARIABLE BLOCK AND DAMPING FORCE VARIABLE SHOCK ABSORBER WITH THE SAME

(71) Applicant: HL MANDO CORPORATION, Gyeonggi-do (KR)

(72) Inventors: Youngjae KIM, Gyeonggi-do (KR); Mookwon KIM, Gyeonggi-do (KR); Byeongsang SON, Gyeonggi-do (KR)

(21) Appl. No.: 19/221,335

(22) Filed: May 28, 2025

(30) Foreign Application Priority Data
May 29, 2024 (KR) 10-2024-0069755

(51) Int. Cl. F16F 9/48; F16F 9/34

(52) U.S. Cl. CPC F16F 9/48; F16F 9/34; F16F 2222/12

(57) ABSTRACT

A damping force variable block according to an embodiment of the present disclosure includes: a block body having a circular hole formed through both ends thereof so that an inner tube can be inserted; a first valve coupling portion formed on a side of the block body and having a rebound solenoid valve coupled thereto; and a second valve coupling portion formed on the side of the block body and having a compression solenoid valve coupled thereto.

### CROSS-REFERENCE TO RELATED APPLICATIONS

This application claims the benefit of and priority to Korean Patent Application No. 10-2024-0069755, filed on May 29, 2024, the entire disclosure(s) of which is hereby incorporated herein by reference in its entirety.

### TECHNICAL FIELD

The present disclosure relates to a damping force variable block and a damping force variable shock absorber including the damping force variable block and, in more detail, to a damping force variable block that is coupled to a dual solenoid valve, and a damping force variable shock absorber including the damping force variable block.

### BACKGROUND

In general, vehicles are equipped with damping devices for improving the ride comfort by reducing shocks or vibrations transmitted to the axle from the road surface during driving, and a shock absorber is used as one of such damping devices.

A shock absorber is also called a damper and operates in response to vibrations of a vehicle that depend on road conditions. In this case, the damping force generated by the shock absorber varies depending on its operation speed, that is, whether the operation speed is high or low.

For example, a shock absorber has the characteristic that when the damping force is set at a low level, it can improve ride comfort by absorbing vibrations caused by road surface unevenness, whereas when the damping force is set at a high level, posture variations of a car body are suppressed, thus improving steering stability. Accordingly, it has been common in the related art to select and apply shock absorbers with different damping force characteristics, depending on the intended use of vehicles.

Recently, various types of damping force variable shock absorbers that can appropriately adjust the damping force characteristics in accordance with road conditions, driving states, etc. by being equipped with damping force variable valves that can appropriately adjust the damping force characteristics of shock absorbers have been developed, and shock absorbers equipped with dual solenoid valves have also been developed.

However, in shock absorbers equipped with dual solenoid valves, two solenoid valves are arranged in series in the axial direction of the shock absorbers, so it is difficult to secure an installation space, and accordingly, improvements are required. For example, in the case of vehicles to which an air spring is applied, it may be difficult to apply a dual solenoid valve due to interference with the air spring.

Further, in order to mount dual solenoid valves, a connecting port, an O-ring, and additional parts are required, the entire structure becomes complicated, and the structural strength and durability may be deteriorated, so improvements are required.

### SUMMARY

An embodiment of the present disclosure provides a damping force variable block that not only can increase flexibility of installation while using dual solenoid valves, but also can improve structural strength and durability, and a damping force variable shock absorber including the damping force variable block.

A damping force variable block according to an embodiment of the present disclosure includes: a block body having a circular hole formed through both ends thereof so that an inner tube can be inserted; a first valve coupling portion formed on a side of the block body and having a rebound solenoid valve coupled thereto; and a second valve coupling portion formed on the side of the block body and having a compression solenoid valve coupled thereto.

A first end of the block body may be coupled to a first cylinder body, a second end of the block body may be coupled to a second cylinder body, and a separator tube may be disposed between the inner tube and the first cylinder body.

Further, a space between the separator tube and the inner tube may be isolated from a space between the separator tube and the first cylinder body, and the space between the separator tube and the inner tube may be connected with the inside of the inner tube through a tube connection hole formed at the inner tube.

A first valve coupling groove to which the rebound solenoid valve is coupled may be formed in the first valve coupling portion, and a second valve coupling groove to which the compression solenoid valve is coupled may be formed in the second valve coupling portion. Further, the block body may have: a separator connection hole connecting a space between the separator tube and the inner tube to the first valve coupling groove; a rebound operation channel connecting the first valve coupling groove and the inside of the inner tube; a compression operation channel connecting the second valve coupling groove and the inside of the inner tube; and a reservoir connection hole connecting a space between the second cylinder body and the inner tube to the second valve coupling groove.

A first inner through-hole connected with the rebound operation channel and a second inner through-hole connected with the compression operation channel may be further formed at the inner tube.

The first valve coupling portion and the second valve coupling portion may be disposed on a common plane that intersects an axis of the hole formed in the block body.

The first valve coupling portion and the second valve coupling portion may be formed to have an intersection angle within a range of 45° to 180°

The rebound solenoid valve may be coupled to the first valve coupling portion in surface contact with the first valve coupling groove, and the compression solenoid valve may be coupled to the second valve coupling portion in surface contact with the second valve coupling groove.

A metal seal may be disposed on a contact surface between the rebound solenoid valve and the first valve coupling groove and a contact surface between the compression solenoid valve and the second valve coupling groove.

Further, a damping force variable shock absorber according to an embodiment of the present disclosure includes: a damping force variable block; a first cylinder body and a second cylinder body coupled to both ends of the damping force variable block, respectively; an inner tube installed in the first cylinder body, the damping force variable block, and the second cylinder body; a piston valve installed to be movable in the inner tube; a separator tube installed between the first cylinder body and the inner tube; a rebound solenoid valve coupled to the damping force variable block; and a compression solenoid valve coupled to the damping force variable block. Further, the damping force variable block includes: a block body having a circular hole formed through both ends thereof so that an inner tube can be inserted, and coupled to the first cylinder body at a first end and coupled to the second cylinder body at a second end; a first valve coupling portion formed on a side of the block body such that the rebound solenoid valve is coupled thereto; and a second valve coupling portion formed on the side of the block body such that the compression solenoid valve is coupled thereto.

A space between the separator tube and the inner tube may be isolated from a space between the separator tube and the first cylinder body, and the space between the separator tube and the inner tube may be connected with the inside of the inner tube through a tube connection hole formed at the inner tube.

A first valve coupling groove to which the rebound solenoid valve is coupled may be formed in the first valve coupling portion, and a second valve coupling groove to which the compression solenoid valve is coupled may be formed in the second valve coupling portion. Further, the block body may have: a separator connection hole connecting a space between the separator tube and the inner tube to the first valve coupling groove; a rebound operation channel connecting the first valve coupling groove and the inside of the inner tube; a compression operation channel connecting the second valve coupling groove and the inside of the inner tube; and a reservoir connection hole connecting a space between the second cylinder body and the inner tube to the second valve coupling groove.

A first inner through-hole connected with the rebound operation channel and a second inner through-hole connected with the compression operation channel may be further formed at the inner tube.

The first valve coupling portion and the second valve coupling portion may be disposed on a common plane that intersects an axis of the hole formed in the block body.

The first valve coupling portion and the second valve coupling portion may be formed to have an intersection angle within a range of 45° to 180°.

The rebound solenoid valve may be coupled to the first valve coupling portion in surface contact with the first valve coupling groove, and the compression solenoid valve may be coupled to the second valve coupling portion in surface contact with the second valve coupling groove.

A metal seal may be disposed on a contact surface between the rebound solenoid valve and the first valve coupling groove and a contact surface between the compression solenoid valve and the second valve coupling groove.

The damping force variable shock absorber may further include a piston rod of which a first end is coupled to the piston valve and reciprocates in the inner tube and of which a second end extends to protrude out of the first cylinder body.

Further, the damping force variable shock absorber may be configured such that when the piston valve is moved toward the first cylinder body from the second cylinder body in a rebound stroke, an operating fluid between the inner tube and the separator tube flows into the rebound solenoid valve coupled to the first valve coupling portion through the separator connection hole of the damping force variable block, and then moves into the inner tube through the rebound operation channel of the damping force variable block.

Further, the damping force variable shock absorber may be configured such that when the piston valve is moved toward the second cylinder body from the first cylinder body in a compression stroke, an operating fluid in the inner tube flows into the compression solenoid valve coupled to the second valve coupling portion through the compression operation channel of the damping force variable block, and then moves to the space between the inner tube and the second cylinder body through the reservoir connection hole of the damping force variable block.

### Advantageous Effects

According to an embodiment of the present disclosure, a damping force variable block and a damping force variable shock absorber including the damping force variable block not only can increase flexibility of installation while using dual solenoid valves, but can improve the structural strength and durability.

### BRIEF DESCRIPTION OF THE DRAWINGS

FIG. 1 is a perspective view of a damping force variable shock absorber according to an embodiment of the present disclosure.

FIG. 2 is an enlarged cross-sectional view highlighting a damping force variable block used in the damping force variable shock absorber of FIG. 1.

FIG. 3 is a perspective view showing one side of the damping force variable block used in the damping force variable shock absorber of FIG. 1, as seen from above.

FIG. 4 is a perspective view showing another side of the damping force variable block of FIG. 3, as seen from below.

FIG. 5 is a vertical cross-sectional view of the damping force variable block of FIG. 3.

FIG. 6 shows flow of an operating fluid during a rebound stroke of the damping force variable shock absorber according to an embodiment of the present disclosure.

FIG. 7 shows flow of an operating fluid during a compression stroke of the damping force variable shock absorber according to an embodiment of the present disclosure.

### DETAILED DESCRIPTION

Hereafter, embodiments of the present disclosure will be described in detail with reference to the accompanying drawings so that those skilled in the art can easily accomplish the present disclosure. The present disclosure can be implemented in various different ways and is not limited to the embodiments described herein.

It should be noted that the drawings are schematic and are not constructed to fit the scales. The relative dimensions and ratios of the parts shown in the figures are exaggerated and reduced for clarity and convenience and certain dimensions are only examples without limiting the parts. The same structures, components, or parts shown in two or more drawings are given the same reference numerals to show similar characteristics.

Embodiments of the present disclosure show ideal embodiments of the present disclosure in detail. Accordingly, various changes may be predicted in the diagrams. Therefore, embodiments are not limited to specific shapes in regions shown in the figures, and for example, include also changes in shape by manufacturing.

Further, in the flowing description, unless otherwise defined, all terms including technical and scientific terms used herein have the same meaning as commonly understood by those skilled in the art to which this disclosure belongs. All terms used herein are selected not to limit the scope of the present disclosure, but to make the present disclosure clearer.

Further, the terms “comprise”, “include”, “have”, etc. used herein should be understood as open-ended terms implying the possibility of including other embodiments, unless stated otherwise in phrases and sentences including the terms.

Further, the singular forms described herein are intended to include the plural forms as well, unless the context clearly indicates otherwise, and which will be applied in the same way to those in claims.

Further, terms such as “first”, “second”, etc. are used only for the purpose of distinguishing a plurality of constitutive elements from other constitutive elements, rather than to limit the order or priority of the constitutive elements.

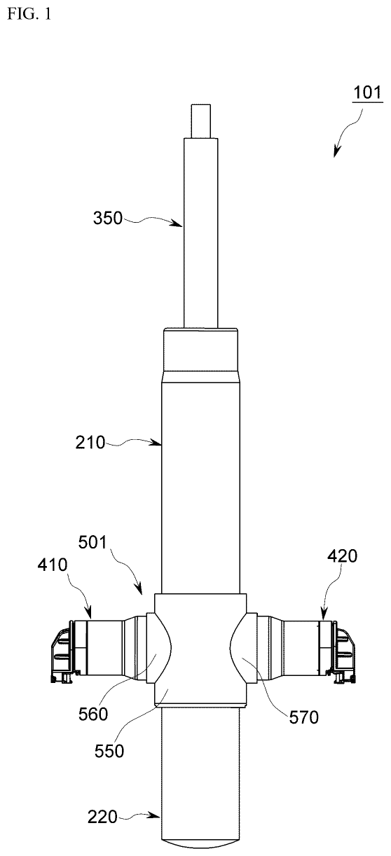

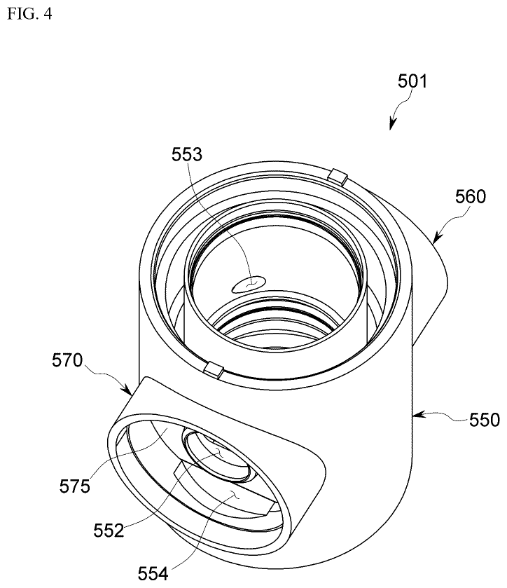

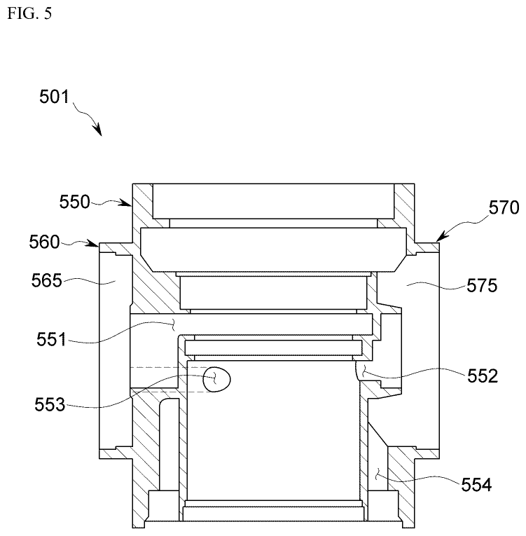

Hereafter, a damping force variable block 501 according to an embodiment of the present disclosure and a damping force variable shock absorber 101 including the damping force variable block are described with reference to FIG. 1 to FIG. 7. The shock absorber stated herein is also called a damper, and for example, may be installed in a vehicle and used to absorb and reduce shocks or vibrations transmitted to the axle from the road surface. Further, the damping force variable shock absorber 101 according to an embodiment of the present disclosure is equipped with dual solenoid valves 310 and 320, thereby being able to appropriately adjust a damping force characteristic on the basis of the road surface, driving state, etc.

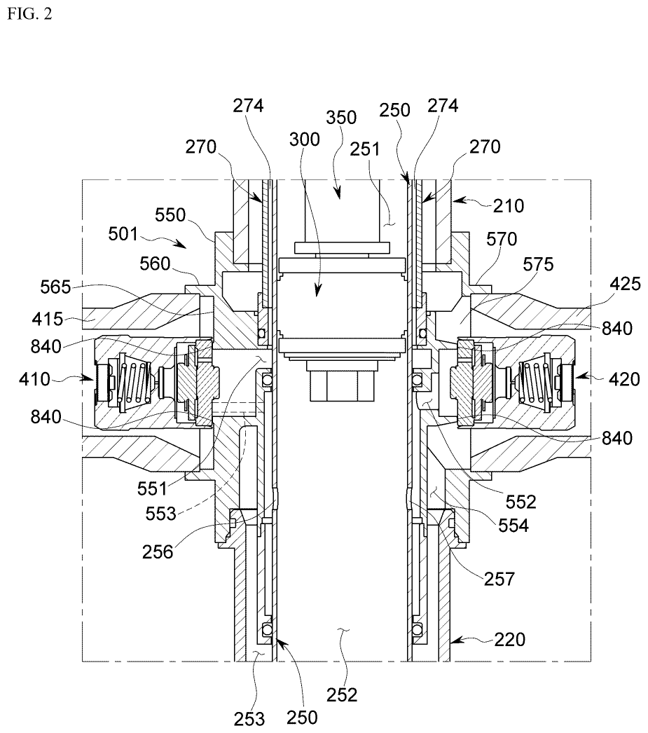

As shown in FIG. 1 and FIG. 2, the damping force variable shock absorber 101 includes a damping force variable block 501, a first cylinder body 210, a second cylinder body 220, an inner tube 250, a piston valve 300, a piston rod 350, a separator tube 270, a rebound solenoid valve 410, and a compression solenoid valve 420.

The damping force variable block 501 is combined with the first cylinder body 210, second cylinder body 220, the rebound solenoid valve 410, and the compression solenoid valve 420 to be described below.

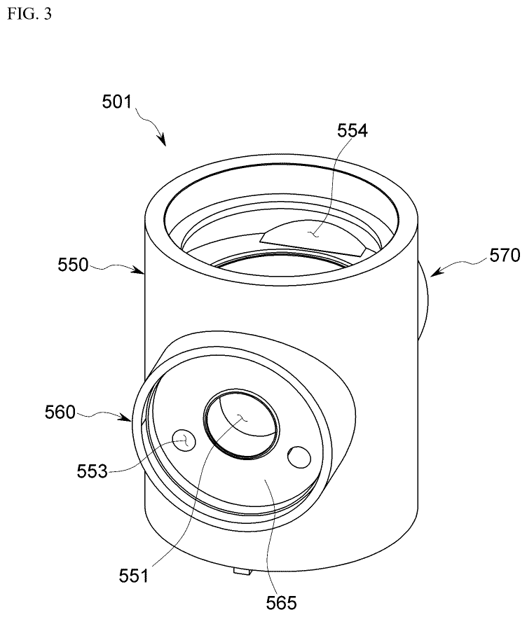

In more detail, as shown in FIG. 3 to FIG. 5, the damping force variable block 501 includes a block body 550, a first valve coupling portion 560, and a second valve coupling portion 570.

A circular hole is formed through both ends of the block body 550 so that the inner tube 250 to be described below can be inserted, and the block body 550 is coupled to the first cylinder body 210 at a first end and is coupled to the second cylinder body 220 at a second end.

The first valve coupling portion 560 is formed on the side of the block body 550 to be coupled to the rebound solenoid valve 410 to be described below. Further, a first valve coupling groove 565 coupled to the rebound solenoid valve 410 may be formed in the first valve coupling portion 560. In this configuration, the rebound solenoid valve 410 may be coupled to the first valve coupling groove 565 together with a rebound solenoid valve housing 415 while being accommodated in the rebound solenoid valve housing 415.

The second valve coupling portion 570 is also formed on the side of the block body 550 to be coupled to the compression solenoid valve 420 to be described below. Further, a second valve coupling groove 575 coupled to the compression solenoid valve 420 may be formed in the second valve coupling portion 570. In this configuration, the compression solenoid valve 420 may be coupled to the second valve coupling groove 575 together with a compression solenoid valve housing 425 while being accommodated in the compression solenoid valve housing 425.

Further, the valve body 550 includes a separator connection hole 551 connecting the space between the separator tube 270 and the inner tube 250 to the first valve coupling groove 565, a rebound operation channel 553 connecting the first valve coupling groove 565 and the inside of the inner tube 250, a compression operation channel 552 connecting the second valve coupling groove 575 and the inside of the inner tube 250, and a reservoir connection hole 554 connecting the space between the second cylinder body 220 and the inner tube 250 to the second valve coupling groove 575. In this configuration, the space between the separator tube 270 and the inner tube 250 becomes a separator chamber 274. Further, the space between the second cylinder body 220 and the inner tube 250 becomes a reservoir chamber 253.

That is, the separator connection hole 551 connects the separator chamber 274 to the rebound solenoid valve 410 coupled to the first valve coupling groove 565, and the rebound operation channel 553 connects the rebound solenoid valve 410 coupled to the first valve coupling groove 565 to the inside of the inner tube 250, that is, the compression chamber 252 to be described below. Further, the compression operation channel 552 connects the compression solenoid valve 420 coupled to the second valve coupling groove 575 to the inside of the inner tube 250, that is, the compression chamber 252, and the reservoir connection hole 554 connects the compression solenoid valve 420 coupled to the second valve coupling groove 575 to the reservoir chamber 253.

Further, the first valve coupling portion 560 and the second valve coupling portion 570 may be disposed on a common plane that intersects the axis of the hole formed in the block body 550. That is, the first valve coupling portion 560 and the second valve coupling portion 570 may be formed at the same height with respect to the longitudinal direction of the damping force variable shock absorber 101. Accordingly, the rebound solenoid valve 410 and the compression solenoid valve 420 are also positioned at the same height with respect to the longitudinal direction of the damping force variable shock absorber 101.

As described above, in an embodiment of the present disclosure, the rebound solenoid valve 410 and the compression solenoid valve 420 are not arranged in series in the axial direction of the first cylinder body 210 and the second cylinder body 220. That is, the rebound solenoid valve 410 and the compression solenoid valve 420 are not positioned at different heights with respect to the longitudinal direction of the damping force variable shock absorber 101. Since, as described above, the rebound solenoid valve 410 and the compression solenoid valve 420 are positioned at the same height with respect to the longitudinal direction of the damping force variable shock absorber 101, it is possible to avoid interference with other parts when mounting the damping force variable shock absorber 101 on a vehicle, so it is possible to increase the flexibility of installation. In particular, even in the case of vehicle models equipped with an air suspension, the rebound solenoid valve 410 and the compression solenoid valve 420 can be applied to the damping force variable shock absorber 101 without interference with the air suspension that is usually positioned over the rebound solenoid valve 410 and the compression solenoid valve 420.

In this case, the first valve coupling portion 560 and the second valve coupling portion 570 of the damping force variable block 501 may be formed to have an intersection angle within the range of 45° to 180°. For example, FIG. 1 shows the state in which the intersection angle of the first valve coupling portion 560 and the second valve coupling portion 570 is 180°.

However, in an embodiment of the present disclosure, the first valve coupling portion 560 and the second valve coupling portion 570 may be arranged on opposite sides not only to have an intersection angle of 180°, but also to have various intersection angles, if necessary, so the flexibility of installation can be further increased.

As shown in FIG. 1 and FIG. 2, the first cylinder body 210 is coupled to the first end of the block body 550 of the damping force variable block 501. The second cylinder body 220 is coupled to the second end of the block body 550 of the damping force variable block 501. In this way, the first cylinder body 210, the damping force variable block 501, and the second cylinder body 220 form one cylinder. Further, the cylinder formed in this way can be filled with an operating fluid.

The inner tube 250 is installed in the first cylinder body 210, the damping force variable block 501, and the second cylinder body 220. In this configuration, the inner tube 250 passes through the block body 550 of the damping force variable block 501. Further, the inner tube 250 may include a hollow cylindrical shape. Further, the space between the inner tube 250 and the first cylinder body 210 and the space between the inner tube 250 and the second cylinder body 220 may become a reservoir chamber.

Further, a first inner through-hole 256 connected with the rebound operation channel 553 of the damping force variable block 501, and a second inner through-hole 257 connected with the compression operation channel 552 of the damping force variable block 501 may be formed at the inner tube 250.

The piston valve 300 is installed to be able to reciprocate in the inner tube 250. Further, a compression chamber 252 and a rebound chamber 251 can be divided by the piston valve 300 in the inner tube 250. For example, with respect to the piston valve 300, the rebound chamber 251 may be defined toward the first cylinder body 210 and the compression chamber 252 may be defined toward the second cylinder body 220. Further, the piston valve 300 can generate a damping force by adjusting movement of the operating fluid between the compression chamber 252 and the rebound chamber 251.

A first end of the piston rod 350 is coupled to the piston valve 300 and reciprocates in the inner tube 250, and a second end thereof can extend to protrude out of the first cylinder body 210. For example, the second end of the piston rod 350 may be extended out of the first cylinder body 210 and connected to the car body or wheels of a vehicle.

The separator tube 270 is installed between the first cylinder body 210 and the inner tube 250. In this configuration, the separator tube 270 may be coupled to the outer circumferential surface of the inner tube 250. Further, the space between the separator tube 270 and the inner tube 250 may be isolated from the space between the separator tube 270 and the first cylinder body 210. Further, the space between the separator tube 270 and the inner tube 250 may be connected to the inside of the inner tube 250, that is, the rebound chamber 251 through a tube connection hole (not shown) formed at the inner tube 250. In this configuration, the rebound chamber 251 is expanded or compressed, depending on movement of the piston valve 300, and the tube connection hole may always be formed at the inner tube 250 at the position of the rebound chamber 251. That is, the separator chamber 274 is connected with the rebound chamber 251 through the tube connection hole, and is isolated from the reservoir chamber 253.

The rebound solenoid valve 410 is coupled to the first valve coupling groove 565 of the first valve coupling portion 560 of the damping force variable block 501. The rebound solenoid valve 410 may be coupled to the first valve coupling portion 560 in surface contact with the first valve coupling groove 565. In this configuration, a metal seal 840 may be disposed on the contact surface between the rebound solenoid valve 410 and the first valve coupling groove 565.

The compression solenoid valve 420 is coupled to the second valve coupling groove 575 of the second valve coupling portion 570 of the damping force variable block 501. The compression solenoid valve 420 may be coupled to the second valve coupling portion 570 in surface contact with the second valve coupling groove 575. In this configuration, a metal seal 840 may be disposed on the contact surface between the compression solenoid valve 420 and the second valve coupling groove 575.

Accordingly, in an embodiment of the present disclosure, since the damping force variable shock absorber 101 employs the damping force variable block 501, it is not required to form specific connection ports at the cylinders 210 and 220 to mount the rebound solenoid valve 410 and the compression solenoid valve 420, and it is possible to minimize use of additional parts such as an O-ring. Further, since the metal seal 840 is applied, it is possible to improve the structural strength and durability in comparison to using an O-ring.

According to this configuration, the damping force variable block 501 according to an embodiment of the present disclosure and the damping force variable shock absorber 101 including the damping force variable block not only can increase flexibility of installation, but also can improve the structural strength and durability while using the dual solenoid valves 410 and 420.

In detail, since the rebound solenoid valve 410 and the compression solenoid valve 420 are positioned at the same height with respect to the longitudinal direction of the damping force variable shock absorber 101, it is possible to avoid interference with other parts when mounting the damping force variable shock absorber 101 on a vehicle, so it is possible to increase the flexibility of installation.

In particular, even in the case of vehicle models equipped with an air suspension, the rebound solenoid valve 410 and the compression solenoid valve 420 can be applied to the damping force variable shock absorber 101 without interference with the air suspension that is usually positioned over the rebound solenoid valve 410 and the compression solenoid valve 420.

Further, by using the damping force variable block 501, it is not required to form complicated channels in the cylinders 210 and 220, and it is possible to mount the dual solenoid valves 410 and 420 to the cylinders 210 and 220 simply by coupling the cylinders 210 and 220 to the damping force variable block 501.

Accordingly, the overall assemblability of the damping force variable shock absorber 101 can be improved, and the structural strength and durability can also be improved.

Further, it is possible to apply the metal seal 840 instead of an O-ring, and the rebound solenoid valve 410 and the compression solenoid valve 420 are supported in surface contact, so stability can be further ensured.

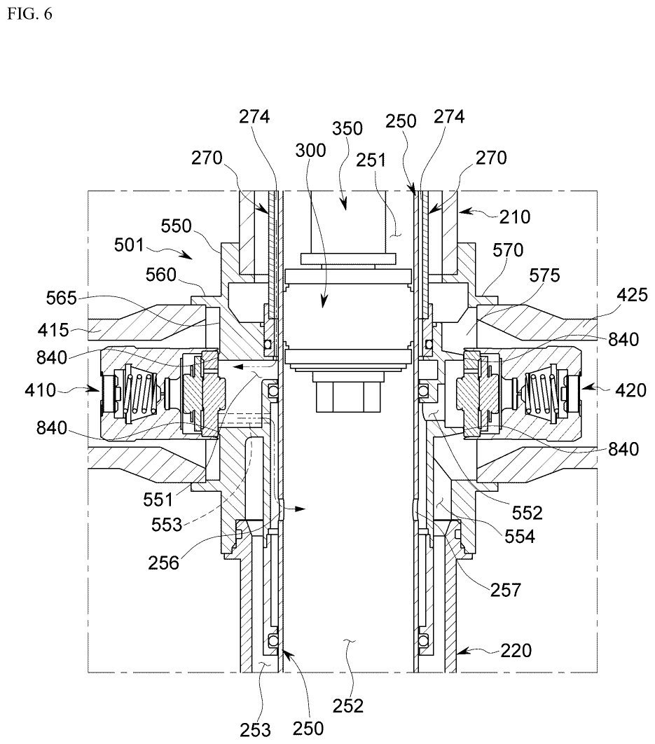

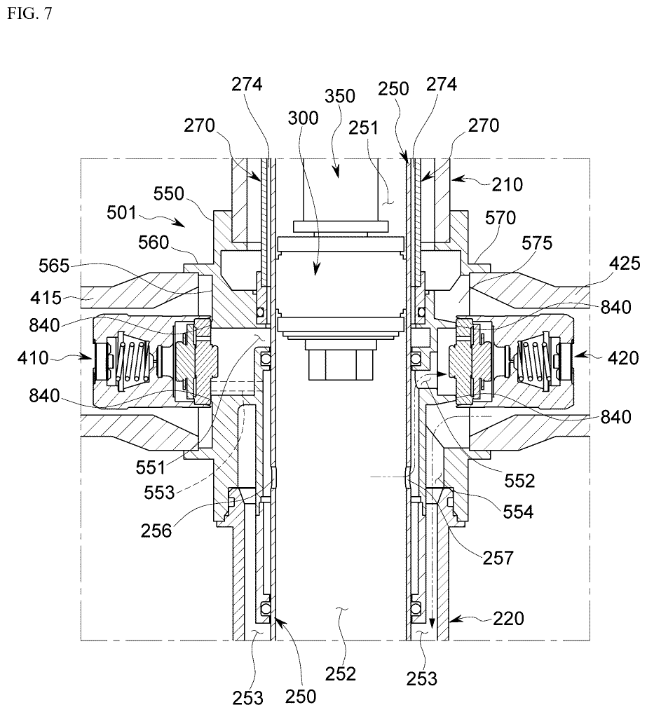

Hereafter, flow of an operating fluid according to the operation of the damping force variable shock absorber 101 according to an embodiment of the present disclosure is described with reference to FIG. 6 and FIG. 7.

First, as shown in FIG. 6, in a rebound stroke, when the piston valve 300 is moved toward the first cylinder body 210 from the second cylinder body 220, that is, when the piston cylinder 300 is moved upward, the operating fluid in the rebound chamber 251 at a relatively high pressure moves to the space between the inner tube 250 and the separator tube 270, that is, to the separator chamber 274 through the tube connection hole, flows into the rebound solenoid valve 410 coupled to the first valve coupling portion 560 through the separator connection hole 551 of the damping force variable block 501, circulates in the rebound solenoid valve 410, and moves into the inner tube 250, that is, to the compression chamber 252 at a relatively low pressure through the rebound operation channel 553 of the damping force variable block 501.

Next, as shown in FIG. 7, in a compression stroke, when the piston valve 300 is moved toward the second cylinder body 220 from the first cylinder body 210, that is, when the piston valve is moved downward, the operating fluid in the inner tube 250 at a relatively high pressure, that is, the operating fluid in the compression chamber 252 flows into the compression solenoid valve 420 coupled to the second valve coupling portion 570 through the compression operation channel 552 of the damping force variable block 501, circulates in the compression solenoid valve 420, and moves to the space between the inner tube 250 and the second cylinder body 220, that is, to the reservoir chamber 253 at a relatively low pressure through the reservoir connection hole 554 of the damping force variable block 501.

Although exemplary embodiments of the present disclosure were described above with reference to the accompanying drawings, those skilled in the art would understand that the present disclosure may be implemented in various ways without changing the necessary features or the spirit of the prevent disclosure.

Therefore, it should be understood that the embodiments described above are not limitative, but only examples in all respects, the scope of the present disclosure is expressed by claims described below, not the detailed description, and it should be construed that all of changes and modifications achieved from the meanings and scope of claims and equivalent concept are included in the scope of the present disclosure.

### DETAILED DESCRIPTION OF MAIN ELEMENTS

101: damping force variable shock absorber
210: first cylinder body
220: second cylinder body
250: inner tube
251: rebound chamber
252: compression chamber
253: reservoir chamber
270: separator tube
274: separator chamber
300: piston valve
350: piston rod
410: rebound solenoid valve
415: rebound solenoid valve housing
420: compression solenoid valve
425: compression solenoid valve housing
501: damping force variable block
550: block body
551: separator connection hole
552: compressio operation channel
553: rebound operation channel
554: reservoir connection hole
5 560: first valve coupling portion
565: first valve coupling groove
570: second valve coupling portion
575: second valve coupling groove
840: metal seal

1. A damping force variable block comprising:
a block body having a circular hole formed through both ends thereof so that an inner tube can be inserted;
a first valve coupling portion formed on a side of the block body and having a rebound solenoid valve coupled thereto; and
a second valve coupling portion formed on the side of the block body and having a compression solenoid valve coupled thereto.

2. The damping force variable block of claim 1, wherein a first end of the block body is coupled to a first cylinder body,
a second end of the block body is coupled to a second cylinder body, and
a separator tube is disposed between the inner tube and the first cylinder body.

3. The damping force variable block of claim 2, wherein
a space between the separator tube and the inner tube is isolated from a space between the separator tube and the first cylinder body, and
the space between the separator tube and the inner tube is connected with the inside of the inner tube through a tube connection hole formed at the inner tube.

4. The damping force variable block of claim 2, wherein a first valve coupling groove to which the rebound solenoid valve is coupled is formed in the first valve coupling portion,
a second valve coupling groove to which the compression solenoid valve is coupled is formed in the second valve coupling portion, and
the block body has:
a separator connection hole connecting a space between the separator tube and the inner tube to the first valve coupling groove;
a rebound operation channel connecting the first valve coupling groove and the inside of the inner tube;
a compression operation channel connecting the second valve coupling groove and the inside of the inner tube; and
a reservoir connection hole connecting a space between the second cylinder body and the inner tube to the second valve coupling groove.

5. The damping force variable block of claim 4, wherein a first inner through-hole connected with the rebound operation channel and a second inner through-hole connected with the compression operation channel are further formed at the inner tube.

6. The damping force variable block of claim 2, wherein a first valve coupling groove to which the rebound solenoid valve is coupled is formed in the first valve coupling portion,
a second valve coupling groove to which the compression solenoid valve is coupled is formed in the second valve coupling portion,
the rebound solenoid valve is coupled to the first valve coupling portion in surface contact with the first valve coupling groove, and
the compression solenoid valve is coupled to the second valve coupling portion in surface contact with the second valve coupling groove.

7. The damping force variable block of claim 2, wherein a first valve coupling groove to which the rebound solenoid valve is coupled is formed in the first valve coupling portion,
a second valve coupling groove to which the compression solenoid valve is coupled is formed in the second valve coupling portion, and
a metal seal is disposed on a contact surface between the rebound solenoid valve and the first valve coupling groove and a contact surface between the compression solenoid valve and the second valve coupling groove.

8. The damping force variable block of claim 1, wherein the first valve coupling portion and the second valve coupling portion are disposed on a common plane that intersects an axis of the hole formed in the block body.

9. The damping force variable block of claim 1, wherein the first valve coupling portion and the second valve coupling portion are formed to have an intersection angle within a range of 45° to 180°.

10. A damping force variable shock absorber comprising:
a damping force variable block;
a first cylinder body and a second cylinder body coupled to both ends of the damping force variable block, respectively;
an inner tube installed in the first cylinder body, the damping force variable block, and the second cylinder body;
a piston valve installed to be movable in the inner tube;
a separator tube installed between the first cylinder body and the inner tube;
a rebound solenoid valve coupled to the damping force variable block; and
a compression solenoid valve coupled to the damping force variable block,
wherein the damping force variable block includes:
a block body having a circular hole formed through both ends thereof so that an inner tube can be inserted, and coupled to the first cylinder body at a first end and coupled to the second cylinder body at a second end;
a first valve coupling portion formed on a side of the block body such that the rebound solenoid valve is coupled thereto; and
a second valve coupling portion formed on the side of the block body such that the compression solenoid valve is coupled thereto.

11. The damping force variable shock absorber of claim 10, wherein a space between the separator tube and the inner tube is isolated from a space between the separator tube and the first cylinder body, and
the space between the separator tube and the inner tube is connected with the inside of the inner tube through a tube connection hole formed at the inner tube.

12. The damping force variable shock absorber of claim 10, wherein a first valve coupling groove to which the rebound solenoid valve is coupled is formed in the first valve coupling portion,
a second valve coupling groove to which the compression solenoid valve is coupled is formed in the second valve coupling portion, and
the block body has:
a separator connection hole connecting a space between the separator tube and the inner tube to the first valve coupling groove;
a rebound operation channel connecting the first valve coupling groove and the inside of the inner tube;
a compression operation channel connecting the second valve coupling groove and the inside of the inner tube; and
a reservoir connection hole connecting a space between the second cylinder body and the inner tube to the second valve coupling groove.

13. The damping force variable shock absorber of claim 12, wherein a first inner through-hole connected with the rebound operation channel and a second inner through-hole connected with the compression operation channel are further formed at the inner tube.

14. The damping force variable shock absorber of claim 12, wherein the rebound solenoid valve is coupled to the first valve coupling portion in surface contact with the first valve coupling groove, and
the compression solenoid valve is coupled to the second valve coupling portion in surface contact with the second valve coupling groove.

15. The damping force variable shock absorber of claim 12, wherein a metal seal is disposed on a contact surface between the rebound solenoid valve and the first valve coupling groove and a contact surface between the compression solenoid valve and the second valve coupling groove.

16. The damping force variable shock absorber of claim 10, wherein the first valve coupling portion and the second valve coupling portion are disposed on a common plane that intersects an axis of the hole formed in the block body.

17. The damping force variable shock absorber of claim 10, wherein the first valve coupling portion and the second valve coupling portion are formed to have an intersection angle within a range of 45° to 180°.

18. The damping force variable shock absorber of claim 10, further comprising a piston rod of which a first end is coupled to the piston valve and reciprocates in the inner tube and of which a second end extends to protrude out of the first cylinder body.

19. The damping force variable shock absorber of claim 12, wherein the damping force variable shock absorber is configured such that when the piston valve is moved toward the first cylinder body from the second cylinder body in a rebound stroke,
an operating fluid between the inner tube and the separator tube flows into the rebound solenoid valve coupled to the first valve coupling portion through the separator connection hole of the damping force variable block, and then moves into the inner tube through the rebound operation channel of the damping force variable block.

20. The damping force variable shock absorber of claim 12, wherein the damping force variable shock absorber is configured such that when the piston valve is moved toward the second cylinder body from the first cylinder body in a compression stroke,
an operating fluid in the inner tube flows into the compression solenoid valve coupled to the second valve coupling portion through the compression operation channel of the damping force variable block, and then moves to the space between the inner tube and the second cylinder body through the reservoir connection hole of the damping force variable block.
